(19) United States
(12) Patent Application Publication
(10) Pub. No.: US 2011/0249104 A1
(43) Pub. Date: Oct. 13, 2011

(54) Peripheral for a Handheld Communication Device

(75) Inventors: Brent Cardillo, Elmwood Park, IL (US); William B. Denniston, JR., Lake Forest, IL (US)

(73) Assignee: SDX-Interactive, Inc., Lincolnwood, IL (US)

(21) Appl. No.: 13/081,850

(22) Filed: Apr. 7, 2011

Related U.S. Application Data
(60) Provisional application No. 61/321,618, filed on Apr. 7, 2010.

(51) Int. Cl. H04N 7/18

(52) U.S. Cl. 348/61; 348/E07.085

(57) ABSTRACT

A peripheral device to a preexisting handheld communication device is disclosed. The peripheral device may include a housing capable of receiving the preexisting handheld communication device, a connector disposed in association with the housing, the connector configured to be removably coupled to the preexisting communication device, and a sensor assembly disposed in association with the housing, the sensor assembly operably associated with the connector assembly. Alternatively, the sensor assembly may be in wireless communication with the preexisting communication device. The sensor assembly preferably includes an optical image sensor for acquiring image information, and a processor for receiving and processing the image information. The sensor assembly may be configured to recover data corresponding to a microscopic code embedded on a surface of an object. Further, the housing may include a conformal cavity to receive the communication device.

This application claims priority to U.S. Provisional Patent Application No. 61/321,618, filed on Apr. 7, 2010, which application is incorporated herein in its entirety.

### FIELD OF THE INVENTION

The present invention relates to handheld communication devices and more specifically to a peripheral for handheld communication devices, such as smart phones, PDAs, MP3 players, tablets, and handheld video devices.

### BACKGROUND OF THE INVENTION

The advent of portable data communication devices that connect a user to a network has resulted in a highly mobile workplace and lifestyle for many people. Mobile phones and other wireless communication devices provide their users with access to networks such as the public switched telephone network and the Internet (e.g., using the wireless application protocol (WAP)), as well as local applications. These handheld communication devices facilitate both voice and electronic mail communications for their users and can be used in or out of the office, making them virtually indispensable to a wide range of users. Businessmen who travel frequently have come to rely on their portable communication devices or other personal digital assistants (PDAs) to keep them in touch with their clients and employees. In just about every profession, professionals capitalize the many advantages portable communication devices provide, including quick access to phone service, e-mails, and the web, and the ubiquitous PDAs have addressed this need.

In the business world, real-time communications between remote workers and headquarters is important in today's fast-paced environment. In the areas of law enforcement and medicine instant communication provides critical advantages. And even in the non-business environment, real-time communications between people has made it easier to organize and keep track of busy personal lives, and the immediate availability of various applications has become important to users, both in their business lives as well as their personal lives. Though today's popular hand held communication devices and other PDAs, (often called smart phones and tablets) such as Research in Motion's BlackBerry®, Apple's iPhone®, iPad®, and iPod Touch®, and others (collectively referred to herein as “PDAs”), do address the need for telephonic, Internet (web, e-mail, etc.) and data communication, they fall short when there is a desire for collecting, processing, and/or disseminating data such as bar codes, or for running applications that provide education, entertainment, organizational, or other personal or business value. That need has been addressed by specialty data collection devices as well as augmented portable personal computers such as laptops and notebooks, but these devices can be too large and heavy for regular users, particularly travelers, the elderly, or petite individuals, such as small women and juveniles.

Other issues include the problem of on-the-go or in-the-field use, which may occur in environments that are unsuitable for most computer systems. Dirt, dust, liquid spills, moisture, excessive heat, and mechanical impacts such as caused by dropping can damage the sensitive components of most computers and electronic devices. Once again, the makers of specialty devices and portable computers such as notebook computers have addressed this need by “ruggedizing” their notebook systems. One drawback to ruggedized notebook computers is that they generally cost and weigh more than their less rugged counterparts. In addition, the size and weight becomes a problem when they are used in the field and must be carried and transported by the user for extended periods of time.

U.S. Pat. No. 7,663,878 addresses the issue of ruggedization as related to the use of handheld communication devices in the field. This patent relates to ruggedized housings for such devices, which can also contain peripherals tailored to a user's various needs and requirements. However, it is not always necessary, or even desirable, to provide ruggedization to a housing for a handheld device. There are situations where a lightweight intelligent housing is preferable. For example, if portability is of consequence, a heavy, ruggedized housing would be not desirable because of the difficulty with carrying these notebooks over long distances or for a long period of time.

There is a need for a device, which combines the lightweight portability of a mobile communicating style PDA with the data gathering ability of a specialty device, and the computing power of a notebook system.

There is also a need for a peripheral device that can be connected to a handheld communication device or PDA, which has a connector assembly and a sensor assembly, and which allows for information to be gathered by the sensor assembly, and then transmitted to, and processed by, the handheld communication device or PDA.

### BRIEF SUMMARY OF THE INVENTION

A peripheral device for coupling with a handheld communication device is disclosed. An interface between the handheld communication device and a processor is provided for performing functions complementary to the communication device. The peripheral device may comprise a conformal cavity for receiving a handheld communication device in a secure and protected fashion. Alternatively, it may provide a partial housing adapted to receive the handheld communication device, or it may be adapted to be received by the handheld communication device via a port in the in the device, which may be a USB port.

In one embodiment, active functional devices may be included in the peripheral housing, including a data collection device. In such an implementation of a housing embodiment, the disclosed housing or peripheral device comprises a data collection device for collecting data and using the interface for sending the collected data to a remote processor for further processing. The data collection device can comprise an image reader, a barcode reader, a signature capture device, an object identifier (OID) device, and/or an optical character recognition (OCR) device. The peripheral may be powered by the power supply of the handheld communication device, or it may be powered by a battery or an AC adaptor. In another embodiment, there is a power subsystem that powers the peripheral device and the handheld communication device. In one implementation, the housing or peripheral device may comprise a plurality of processors and data collection devices that work in conjunction with software installed on the handheld communication device to which the peripheral device is connected. The software can be installed by any known means, including through a disk-based installation, or by downloading the software from a web site. Alternatively, the software can be installed in the peripheral device itself, also via disk-based installation or by downloading the software from a web site.

Also disclosed is a peripheral for a handheld communication device comprising a connector assembly including at least one connector for connecting with the communication device; and a sensor assembly. The sensor assembly may include an optical image sensor for reading microscopic codes embedded on the surface of an object (sometimes referred to as optical identification codes); a processor capable of converting a recognized optical identification code into an integer value such as American Standard Code for Information Interchange (ASCII) string of digits; and a connector for transmitting the string of digits to the communication device.

Also disclosed is a peripheral to a preexisting handheld communication device, comprising a housing capable of receiving the preexisting handheld communication device; a connector assembly disposed in association with the housing, the connector assembly configured to be removably coupled to the preexisting communication device; and a sensor assembly disposed in association with the housing. The sensor assembly is operably associated with the connector assembly and includes an optical image sensor for acquiring image information; and a processor for receiving and processing the image information. In another embodiment, the connector, which may be a USB connector, conveys power from the preexisting communication device to the sensor assembly. Alternatively, a battery can be included in the housing for providing power to the peripheral. Further, the sensor assembly is removable from the housing by an end user, and is also configured to recover data corresponding to a microscopic code embedded on a surface of an object. The housing can have a conformal cavity to receive the communication device. The conformal cavity can have a protective window which protects the display screen of the communication device. This protective window can be made of a poly carbonate plastic, such as, but not limited to, LEXAN®, or acrylonitrile butadiene styrene (ABS) plastic.

In another embodiment, the invention relates to a method for utilizing a peripheral device in association with a preexisting handheld communication device comprising receiving the preexisting handheld communication device via a housing of the peripheral device; removably coupling the preexisting handheld communication device to a connector assembly disposed in the housing of the peripheral device; and generating user data via a sensor assembly disposed in association with the housing. The sensor assembly includes an optical image sensor for acquiring image information and a processor for receiving and processing the image information to generate the user data. The preexisting communication device can be received via a conformal cavity in the housing. The method can further comprise conveying power from the preexisting handheld communication device to the sensor assembly via the connector assembly, wherein the power can be conveyed via a USB connector. Alternatively, a battery can be included in the housing for providing power to the peripheral. Further, the sensor assembly is removable from the housing by an end user. In one embodiment, user data corresponds to a microscopic code embedded on a surface of an object. The display screen of the preexisting handheld communication device can be protected by a protective window positioned over the conformal cavity, which can be made of polycarbonate plastic or acrylonitrile butadiene styrene (ABS) plastic. In another embodiment, a housing for a handheld device comprises a back portion having a well for holding the handheld device. The device fits into the well of the housing. The housing includes a sensor assembly and a connector assembly, so that the intelligent features of the housing can be accessed by a user. The housing can be made from a material that is capable of protecting and preventing damage to the device.

Yet another embodiment of the invention relates to a peripheral to a preexisting handheld communication device, consisting essentially of a housing; a power source; a wireless communication assembly disposed in the housing; and a sensor assembly disposed the housing. The sensor assembly may be operably associated with the wireless communication assembly, and is capable of establishing an operable wireless link with a preexisting handheld communication device.

Another embodiment of the invention relates to a method for utilizing a peripheral device in association with a preexisting handheld communication device, the method comprising establishing a wireless communication link between a preexisting handheld communication device and a peripheral device; and generating user data via the sensor assembly. The peripheral device consists essentially of a housing with a power source; a wireless communication assembly disposed in the housing; and a sensor assembly disposed the housing, the sensor assembly operably associated with the wireless communication assembly.

Another embodiment of the invention relates to a method for utilizing a peripheral device in association with a preexisting handheld communication device, the method comprising establishing a wireless communication link between a preexisting handheld communication device and a peripheral device; and generating user data via the sensor assembly. The peripheral device may include a housing; a power source; a wireless communication assembly disposed in the housing; and a sensor assembly disposed the housing, the sensor assembly operably associated with the wireless communication assembly.

In another embodiment, the invention relates to a peripheral to a preexisting handheld communication device consisting essentially of a housing capable of receiving the preexisting handheld communication device; a power source; a wireless communication assembly disposed in association with the housing; and a sensor assembly disposed in association with the housing. The sensor assembly may be operably associated with the wireless communication assembly and may include an optical image sensor for acquiring image information and a processor for receiving and processing the image information.

In another embodiment, the invention relates to a method for utilizing a peripheral device in association with a preexisting handheld communication device comprising receiving the preexisting handheld communication device via a housing of the peripheral device; and generating user data via a sensor assembly disposed in association with the housing, The sensor assembly may include an optical image sensor for acquiring image information and a processor for receiving and processing the image information to generate the user data.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 illustrates components of the sensor and connector assemblies of the peripheral.

FIG. 2 illustrates a peripheral having a holster-style housing for use in connection with a handheld communication device, the peripheral having a sensor assembly and a connector assembly.

FIGS. 3A-3C depict illustrations of another embodiment of the housing, where the housing fully surrounds the handheld communication device. FIG. 3A shows the housing without the communication device. FIG. 3B shows a communication device in the process of connecting with the housing. FIG. 3C shows the housing holding a communication device.

FIG. 4 is an illustration of a person using one implementation of a peripheral with a handheld device.

FIG. 5 is a front plan view of an embodiment of the housing of the invention.

FIG. 6 is a left side elevational view of the housing of FIG. 5.

FIG. 7 is a back plan view of the housing of FIG. 5.

FIG. 8 is a right side elevational view of the housing of FIG. 5.

FIG. 9 is a top elevational view of the housing of FIG. 5.

FIG. 10 is a bottom elevational view of the housing of FIG. 5.

FIG. 11 is a front plan view of another embodiment of a sensor assembly with the cap in place.

FIG. 12 is a front plan view of the sensor assembly of FIG. 11 with the cap removed.

FIG. 13 is a back plan view of the sensor assembly of FIG. 11.

FIG. 14 is a back plan view of the sensor assembly of FIG. 11 with the cap removed.

FIG. 15 illustrates the sensor assembly of FIG. 11 in use.

FIG. 16 illustrates components of the sensor and wireless communication assemblies of the peripheral.

### DETAILED DESCRIPTION OF THE INVENTION

While the present disclosure may be embodied in many different forms, the drawings and discussions are presented with the understanding that the present disclosure is an exemplification of the principles of one or more inventions and is not intended to limit any one of the inventions to the embodiments illustrated.

We describe various embodiments of an interchangeable, relatively inexpensive peripheral for a smart phone, PDA, tablet or other handheld communication device (referred to interchangeably throughout in a general sense as a “handheld communication device” or simply “communication device”). The peripheral may be comprised of a lightweight, yet impact resistant, intelligent housing which partially encases a communication device. Such a housing may at least partially protect the PDA from damage resulting from drops, spills, etc. and/or it may increase the functionality of the communication device with the addition of peripheral processing.

Implementation of an Embodiment for Peripheral Sensor Assembly.

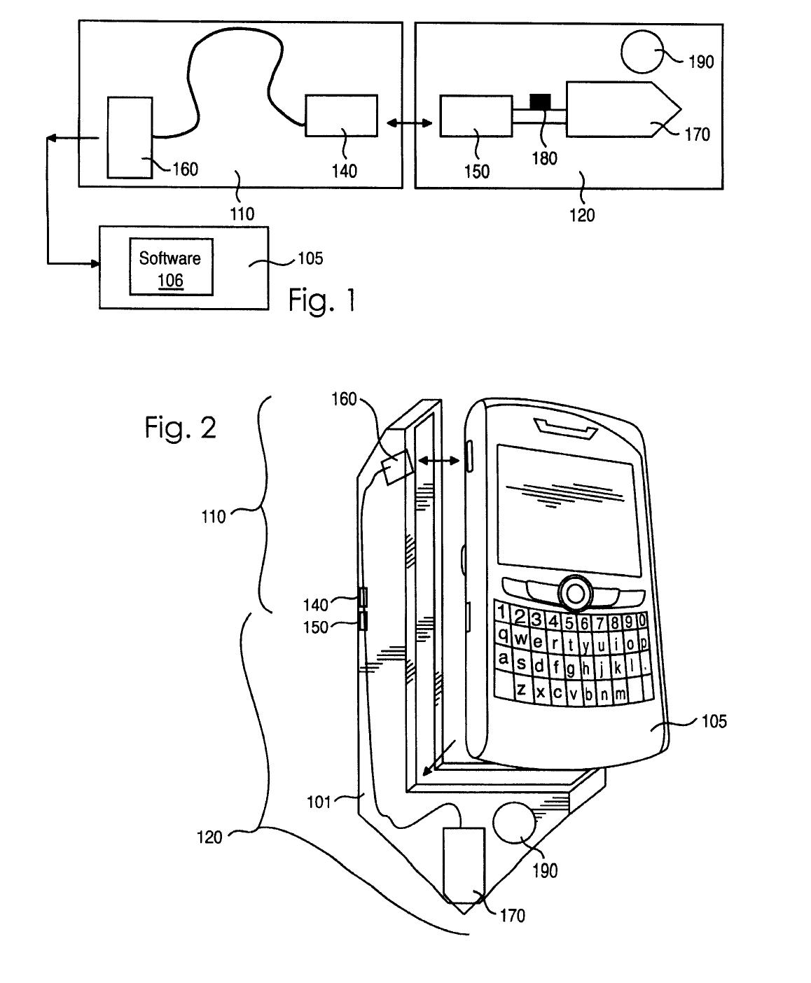

As shown in FIGS. 1 and 2, in one implementation of a peripheral for a communication device according to the invention, a sensor assembly 120 may be incorporated into a housing 101 for use with a pre-existing PDA device 105. As illustrated in FIG. 1, the housing 101 may be a partial housing (i.e., it may not fully surround or encase the communication device 105). The housing 101 further comprises a connector assembly 110, which includes at least one connector 160 for coupling the connector assembly 110 to the communication device 105. As illustrated in FIG. 1 the connector 160 may be a USB connector, however, various types of connectors may be used as will usually be dictated by the manufacturer of the particular communication device 105. The connector assembly 110 may be removably located within the housing 101. The housing 101 also comprises a sensor assembly 120, which includes an optical image sensor 170 for detection and acquiring of image information. The sensor assembly 120 is coupled to the connector assembly 110 via connectors 140, 150, thus allowing transmission of data from the sensor assembly 120 to the communication device 105. The sensor assembly 120 may include a processor 180 for processing and receiving the image information captured by the optical image sensor 170, to generate user data. Alternatively, the processor 180 may be located in the handheld device 105. Where the processor 180 is located in the handheld device, the sensor assembly transmits image data to the handheld device via a communications link. As with the connector assembly 110, the sensor assembly 120 may be removably located within the housing 101. The housing 101 may further include a battery 190 for powering the peripheral. Although the battery 190 may be located at any convenient place in the housing, FIGS. 1 and 2 show the placement of the battery 190 at the tip of the housing 101. The housing 101 may be specific to the form-factor of a particular communication device 105, but the connector assembly 110 and the sensor assembly can be mounted in different housings 101. Preferably, the housing 101 permits single hand coordinated operation of the communication device 105 and the sensor assembly 120 in either a portrait or landscape orientation. Additionally, the housing 101 can act as a carrier for the communication device 105, and may include a clip-on accessory (not shown). The housing 101 provides sturdy mechanical mounting of the sensor assembly 120, and preferably an ergonomically desirable feel for a user holding the communication device 105 and sensor assembly 120 in an operable position. In one embodiment, the connector assembly 110 isolates the sensor assembly 120 from various connectors (USB and other) being used on target devices. In addition, the connector assembly is portable between holsters (or other housing types), as long as the different cell phones or PDA's use the same type of connector.

FIG. 2 illustrates the connector assembly 110 and the sensor assembly 120 in greater detail. The sensor assembly 120 may comprise an optical image sensor 170 used to read microscopic codes embedded on the surface of an object, such as used in the Poingo® reading system (SDX Interactive of Lincolnwood, Ill.), and a processor 180 for processing and receiving the image information captured by the optical image sensor 170, to generate user data. In particular, the processor 180 may be configured to be capable of converting values corresponding to the microscopic codes into user data in the form of a string of digits. The sensor assembly is coupled to the connector assembly 110 via a connector 150, thus allowing transmission of data from the sensor assembly 120 to the communication device 105. The optical image sensor 170 may have a optical character recognition (OCR) function, be a bar code reader, a credit card reader, or any other sensor configured to acquired data and transmit such data. In some embodiments, connector 150 may also be used to transmit power and/or data between the communication device 105 and the sensor assembly 120. This may be accomplished in much the same way that a computer peripheral (such as a mouse or keyboard) may be powered via a host or “hub” side of a USB connection between the host computer and the peripheral. In many applications, the host computer may provide not only power for the connection, but power for operation of the peripheral itself. Similarly, where a communication device 105 is configured to act as a host or “hub” to distribute power to peripherals, the sensor assembly 120 (as well as the connection) may be powered by the communication device 105. In the case where the communication device 105 is not so configured, the sensor assembly 120 would provide its own power, such as via an AC power connection, or a discrete DC power supply (e.g., battery or other power cell). The connector 150 is considered to be part of the sensor assembly 120, and can be located in near proximity to the processor 180 or at a distance (i.e., closer to the connector assembly), depending upon the desired configuration of the housing. The sensor assembly 120 is preferably physically located near an end of the housing 101 so that it can sense and collect information when placed proximate to an encoded surface or medium (such as an encoded book in the Poingo® reading system (SDX Interactive of Lincolnwood, Ill.)), and convert it to a form suitable for processing. The sensor assembly 120 can be made standard for use with many, if not all, cell phone and PDA types, and thus can be interchangeably mounted in any holster assembly. The sensor assembly 120 may be removed from one holster and installed into another by an end user.

Via its connection to the communication device 105, the peripheral sensor assembly 120 can utilize the processing power of the communication device 105, as well as other pre-existing components of the communication device 105, such as speakers for playing audio and/or the GUI/video display for playing animations or other video, or otherwise outputting data or information to a user. The data collected by the sensor assembly 120 can be processed by software 106 installed in the processor located within the communication device 105. Alternatively, a dedicated processor and processing software may be provided within the housing 101 for independent use by the peripheral sensor assembly 120. This software 106 may use information associated with the collected data to output additional information or aural or visual stimulations via an audio speaker or graphical user interface (GUI) in the communication device 105. The software 106 can be installed through a disk-based installation, or by downloading the software 106 onto the communication device 105 from a central server via wireless or wired connection.

Other types of known sensor assemblies 120 may be used in association with the system, such as sensors for optical character recognition (OCR) functions, bar code readers, credit card readers, object identifier (OID) functions or any other sensor configured to acquired data and transmit such data (either as acquired, or as processed by the processor 180) to the communication device 105. In one implementation of an embodiment, multiple peripheral assemblies (including, by way of example, other sensor assemblies 120 and/or other functional peripherals such as a GPS enabling assembly, or an interactive voice response (IVR) assembly) may be interchangeably removed or added to the housing 101 as necessary to address different sensing or other functional requirements. In another implementation of an embodiment, sensor assemblies having multiple functions may be employed. The housing 101 manages the peripheral assemblies or devices that are configured to be removably mounted within the housing 101, via which such peripheral device 120 may be connected to the communication device 105. in such an embodiment, each of the peripheral devices or assemblies may be added or removed and updated by using an assembly that has substantially the same form factor, regardless of what functionality it provides. Alternatively, the sensor assembly 120 (or other applicable peripheral) may be fixedly incorporated into the housing 101 (which as shown in FIG. 2 may be only a partial housing), and then removed or added as necessary in cooperation with the housing 101 itself.

While the specifications for the housing 101 may be specific to a particular communication device 105, the sensor assembly 120 is preferably standard across all types or variations of communication devices, and may be interchangeably mounted in any housing 101. The sensor assembly 120 may be removed from one housing 101, and installed in another by an end user, so that it may be used with a different communication devices 105. The entire connector assembly 110 may also be removed from one housing 101 and installed in another housing 101 by the user. In certain implementations, the connector assembly 110 may be device specific, however it can be removed from one housing 101, and installed in another for use with a communication device that uses the same type of connector. The connector assembly 110 isolates the sensor assembly 120 from the various connectors 140, 150 used on target devices, which makes the assembly 120 portable between separate housings 101.

In one embodiment of a sensor (or other peripheral) in a housing (or partial housing) form, the housing 101 can use the communication function of the communication device 105 to wirelessly transmit to a remote device any data collected with the sensor assembly 120. The housing 101 may act as a host for the handheld communication device 105 (which may also be referred to as the guest device), which is received by the housing 101. As later described herein, the host housing 101 may include one or more of a variety of functions that are complementary to and fully compatible with those of the guest communication device 105.

The communication device 105 is any of several commercially available handheld communication devices. This includes by way of example only, but is not limited to, BlackBerry® communication device made by Research In Motion Corporation of Canada, the iPhone® or iPad® by Apple, the Palm Pre®, and the Android™ phones. It should be understood that other handheld communication devices can also be used with the invention. The communication device 105 can include circuitry to enable a variety of communications (not shown), including a two-way radio, telephone, and electronic mail.

It will be understood that the housing 101 does not have to be physically attached to, or in close proximity with, the communication device 105 in order for the housing 101 to perform the functions it is meant to perform. In one embodiment, the housing 101 can be connected to the communication device 105 by means of a wireless link (such as, but not limited to, radio-frequency, Bluetooth®, Zigbee®, WiFi, or infrared). In such an embodiment, the communication device 105 may be updated post-manufacture, or may be pre-manufactured, to contain appropriate wireless interface software, hardware or firmware so that it is configured to communicate wirelessly with the housing 101. In most cases, the communication device 105 will already contain a communication interface by virtue of its being a wireless mobile phone, but may contain additional local limited distance wireless connection capabilities (such as WiFi, Bluetooth®, Wireless USB, Zigbee®, etc.). If the communication device 105 contains such a local, limited distance wireless capability, then configuring the device to communicate wirelessly with the housing 101 may be as simple as providing a compatible wireless link to the housing 101 and an interface to wirelessly transmit (receive) signals to (from) the user. The communication device 105 can be placed in a relatively safe place (e.g., its own case or in the users' pocket) and the housing 101 can be used in the field where its own features of being lightweight and portable allow for ease of use.

In another embodiment, the communication device 105 can enter a “resting” pattern. When inactivity is detected for a sufficient period of time, the communication device 105 can enter a much lower power consumption mode or, in certain cases actually turn off. When a movement pattern occurs, an electronic trigger will provide a signal to the communication device and return the unit to full operational speed. In another embodiment, the communication device 105 can turn on automatically, if it had been turned completely off.

Implementation of an Embodiment for Protective Peripheral Sensor Assembly.

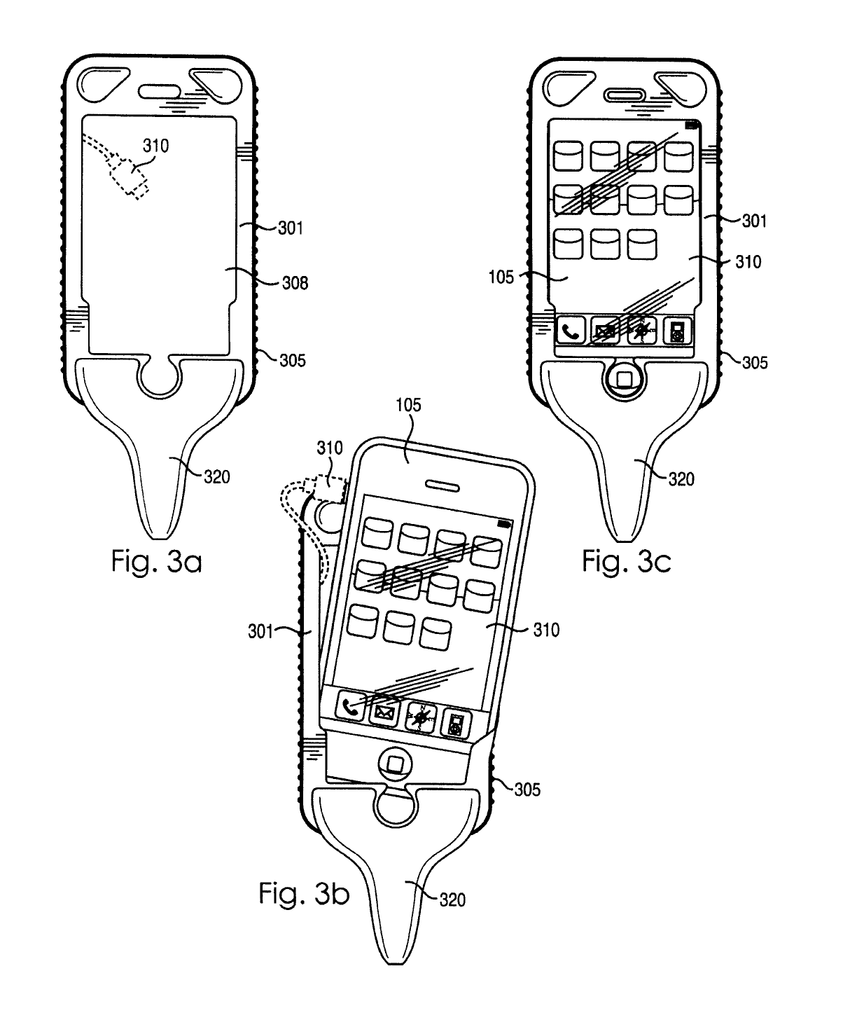

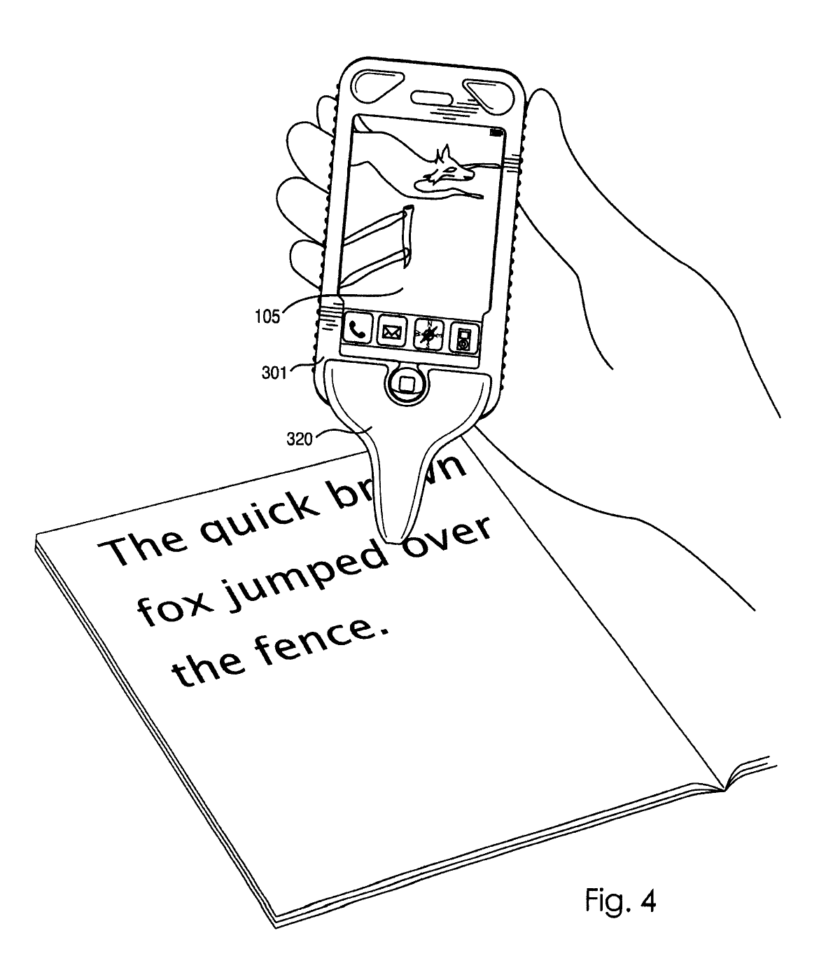

Turning to FIG. 3A, an alternative embodiment for a housing 301 is illustrated. In this embodiment, the housing 301 encases substantially the entire peripheral of the communication device 105, and has a conformal cavity 308, into which a communication device 105 is placed and held (as shown in FIG. 3C, which illustrates the embodiment of the housing 301, as described above, but without the communication device 105 in place). FIG. 3B shows how the communication device 105 is inserted into or received by the housing 301, and FIG. 4 illustrates a single hand operation of the communication device 105 received by the housing 301 shown in FIGS. 3A-3C. The housing 301 illustrated in FIGS. 3A-3C not only supplies the functionality of the housings described above (and further explained below), but may also provide for a level of protection for the communication device 105. Here, the housing 301 can be made of a strong, resilient material, such as, by way of example only, a siliconized material, neoprene, acrylonitrile butadiene styrene (ABS) plastics, a rubberized material, or a combination thereof

As explained above with respect to the embodiment of FIG. 2, the housing 301 includes a sensor assembly 320. In an implementation such as that described with respect to FIGS. 3A-3C, the sensor 320 assembly is attached, either fixedly or removably, to the housing 301. The sensor assembly may be attached using, for example, an adhesive, a click-fit, a friction fit, or other known coupling mechanism. Alternatively, the housing portion of the sensor assembly may be integrally molded with the housing 301 that encases the communication device 105. The housing 301 may further include a series of raised ridges 305, which enables a user to grip the housing 301 securely, reducing the risk of dropping the device 105. By using a resilient material such as above-described, a housing 301 which substantially encapsulates at least the periphery of the communication device 105, such as that shown in FIGS. 3A-3C, may fit around the outside of the communication device 105 in a snug relationship forming a strong fit between the housing 301 and the device 105, so that the housing 301 retains the device105 without slippage. With such a snug fit, the combination of the peripheral sensor assembly 1320 and the housing 301, when fit around the communication device 105, effectively creates, or at least gives the appearance of, a single, unitary device.

Another protective aspect of the housing 301 is highlighted with the use of a transparent protective window 310 placed over the display screen of the communication device 105. The protective window 310 fits into an aperture of the housing 301. The protective window can be made of a polycarbonate plastic, such as LEXAN®, or of an (ABS) plastic. If an impact occurs directly to the viewable screen, the clear protective window 310 of the housing 301 takes the loading and then transfers the forces away from the display screen of the communication device 105. The display screen also protects against scratches or smudges to the screen of the communication device 105. The display screens found in many electronics today are very susceptible to point impacts and cracking. By protecting the display screen from direct impact, scratches and smudges, and redirecting any force flow around the communication device 105, damage to the device 105 as a whole can be greatly minimized.

In another embodiment, the communication device 105 has a touch sensitive surface, which may be constructed of two layers of film with a gel interposer. The interposer has the ability to change the voltage potentials. The touch sensitive screen captures button events and signature stroke data. Conventionally the substrate material for touch screens has been glass but in this embodiment the substrate is a clear, impact resistant material. One such material is polycarbonate plastic and one common GE polycarbonate is LEXAN®. When the communication device 105 has a touch sensitive surface, the device 105 can sense the touch of a user or a user's stylus and convert that information or instructions into the user command format of the communication device 105. If the communication device 105 does not include a screen that is touch sensitive, the housing 301 may optionally provide a touch screen (not shown) that acts as an overlay or interposer over the screen and converts the touch information. In this embodiment, it allows the protective window 310 over the communication device 105 to perform in both protective and touch sensitive roles.

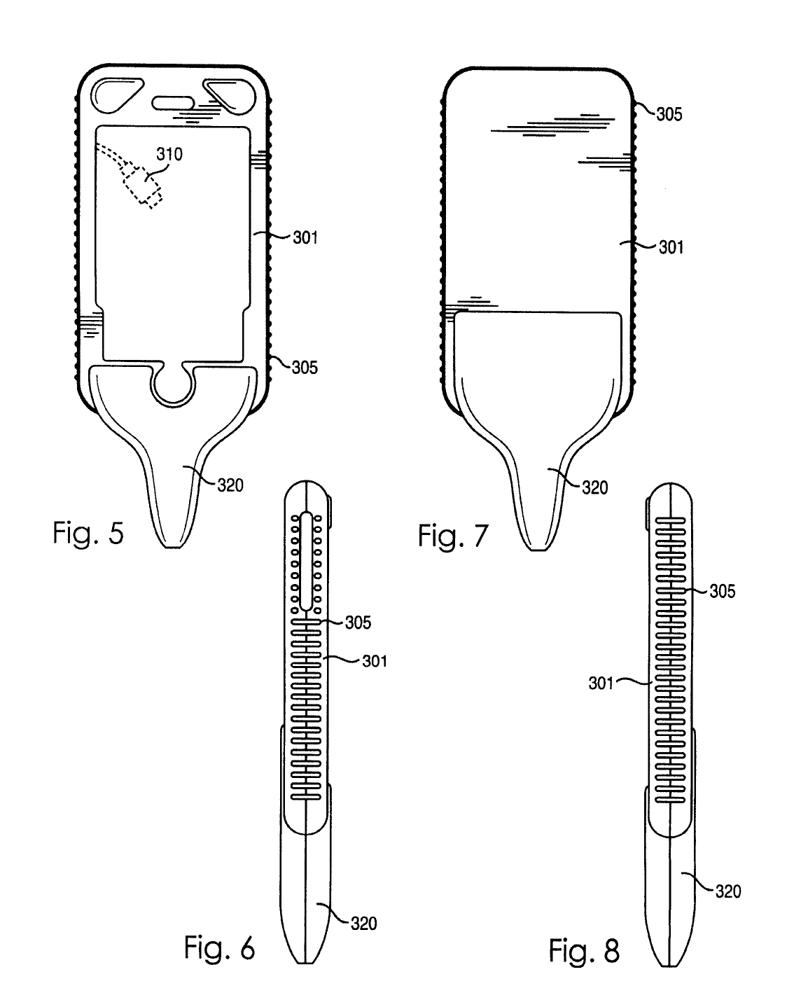

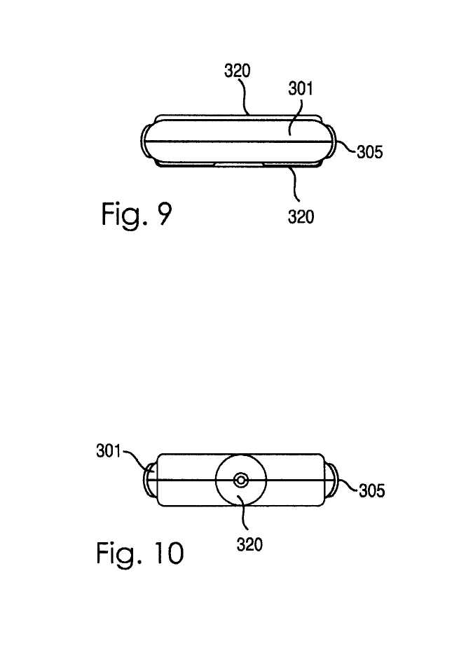

FIG. 5 illustrates a front view of one embodiment of an empty housing 301, also showing the sensor assembly 320. FIG. 6 is a left side view of the housing 301, with the sensor assembly 320 in place. FIG. 7 is a back view of the housing 301, showing the back of the sensor assembly 320. FIG. 8 is a right side view of the housing 301, with the sensor assembly in place. FIGS. 9 and 10 are a top view and a bottom view of the housing 301, with FIG. 10 showing the sensor assembly 320 in place.

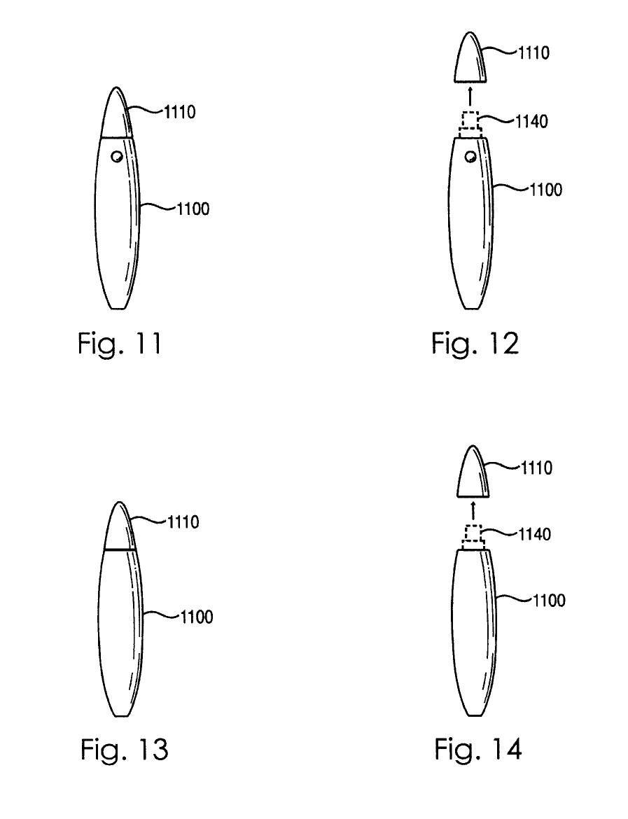

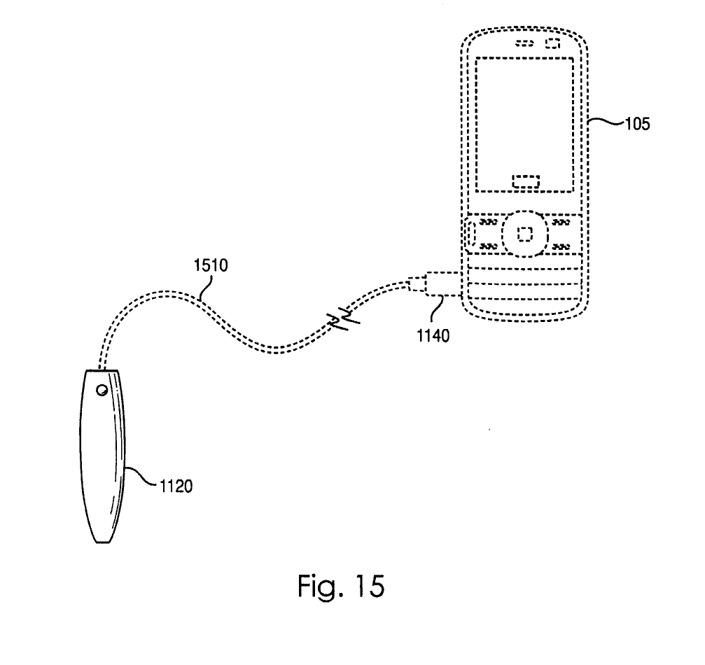

Another embodiment of the invention relates to a sensor assembly 1100 that will attach to a handheld device 105, but which may not necessarily be intended for or as conducive to single-hand operation. Here, the sensor assembly 1100 connects to the communication device 105 via a wire 1510 and connector assembly 1100. FIGS. 11 and 12 are front views of the sensor assembly 1100, with FIG. 12 having the cap 1110 removed, so the connector assembly 1140 can be accessed and connected to the handheld device 105. FIGS. 13 and 14 show the back views of the sensor assembly 1100, with FIG. 14 having the cap 1110 removed, so the connector assembly 1140 can be accessed and connected to the handheld device 105. FIG. 15 illustrates how the connector assembly 1140 connects the sensor assembly 1100 to the handheld device 105 via wire 1510. As suggested in FIGS. 11-15, the wire 1510 may be stored within the housing of the sensor assembly 1100, such that when the cap 1110 is removed, the connector 1140 (to which the wire 1510 is attached), may be pulled out thus extending the wire 1510 as appropriate. When the sensor assembly 1100 is not in use, the wire may be reinserted into the housing the sensor assembly 1100 and retained within such housing by the cap 1110. In one embodiment or implementation, the wire may be neatly and easily stored within the housing of the sensor assembly 1100 using a known retraction mechanism. Alternatively, wire 1510 may be replaced by a wireless communication link, with communication between the sensor assembly 1100 and the handheld device 105 taking place over a wireless connection, such as Bluetooth®, Zigbee®, WiFi, or infrared. In any of the wireless embodiments, the sensor assembly 1100 is able to wirelessly transmit a decoded dot pattern as a multi-digit number that can be processed by the handheld device. Alternatively, the sensor assembly 1100 can transmit the original dot pattern (or raw image) to the handheld device 105, which can then be decoded and processed by the handheld device 105. Image information may be processed by a processor located either within the sensor assembly 1100 or within the handheld device 105.

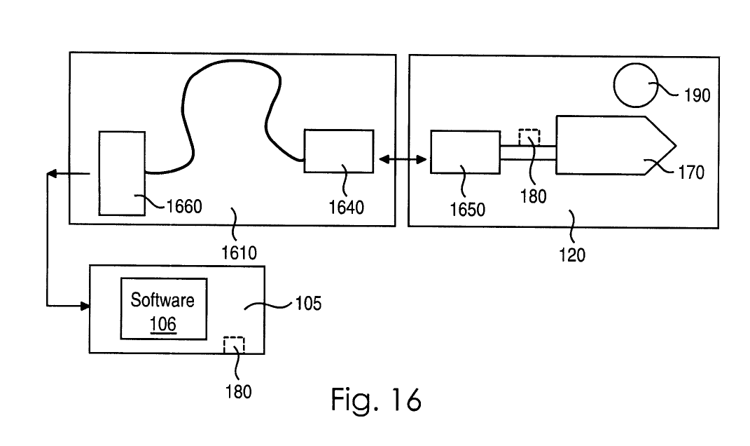

As shown in FIG. 16, in one implementation of a peripheral for a communication device according to the invention, a sensor assembly 120 may be incorporated into a housing 101 for use with a pre-existing PDA device 105. The housing 101 further comprises a wireless communication assembly 1610, which includes at least one wireless link 1660 for wirelessly coupling the wireless communication assembly 1610 to the communication device 105. As illustrated in FIG. 1 the wireless communication device 1660 may include a Bluetooth® transceiver, however, various types of wireless transceivers may be used as will usually be dictated by the manufacturer of the particular communication device 105. The wireless communication assembly 1610 may be removably located within the housing 101. The sensor assembly 120 is coupled to the wireless communication assembly 1610 via wireless links 1640, 1650, thus allowing transmission of data from the sensor assembly 120 to the communication device 105. The sensor assembly 120, which may an optical image sensor 170 for detection and acquiring of image information. The sensor assembly 120 may include a processor 180 for processing and receiving the image information captured by the optical image sensor 170, to generate user data. Alternatively, the processor 180 may be located in the handheld device 105. As with the wireless communication assembly 1610, the sensor assembly 120 may be removably located within the housing 101. The housing 101 may further include a battery 190 for powering the peripheral. Although the battery 190 may be located at any convenient place in the housing, FIG. 16 shows the placement of the battery 190 at the tip of the housing 101. The housing 101 may be specific to the form-factor of a particular communication device 105, but the wireless communication assembly 1610 and the sensor assembly can be mounted in different housings 101. The housing 101 provides sturdy mechanical mounting of the sensor assembly 120, and preferably an ergonomically desirable feel for a user holding the communication device 105 and sensor assembly 120 in an operable position. In addition, the wireless communication assembly 1610 is portable between housing forms, as long as the different cell phones or PDA's use the same type of wireless communication.

The communication between the sensor assembly 120 and the handheld device 105 may use a wireless connection, such as Bluetooth®, Zigbee®, WiFi, or infrared. In any of the wireless embodiments, the sensor assembly 120 is able to wirelessly transmit a decoded dot pattern as a multi-digit number that can be processed by the handheld device. Alternatively, the sensor assembly 120 can transmit the original dot pattern (or raw image) to the handheld device 105, which can then be decoded and processed by the handheld device 105

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. The invention may have other specific forms without departing from its spirit or essential characteristic. For example, any of the housings disclosed herein may have clips, cable channels and other mechanical supporting features to facilitate mounting of the housing both in a convenient and secure manner. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit. All patents, patent applications and publications are hereby incorporated by reference in their entirety

We claim:

1. A peripheral to a preexisting handheld communication device, comprising:
a housing capable of receiving the preexisting handheld communication device;
a connector assembly disposed in association with the housing, the connector assembly configured to be removably coupled to the preexisting communication device; and
a sensor assembly disposed in association with the housing, the sensor assembly operably associated with the connector assembly and including:
an optical image sensor for acquiring image information; and
a processor for receiving and processing the image information.

2. The peripheral of claim 1, wherein the connector conveys power from the preexisting handheld communication device to the sensor assembly.

3. The peripheral of claim 2, wherein the connector assembly comprises a USB connector.

4. The peripheral of claim 1, wherein the sensor assembly is removable from the housing by an end user.

5. The peripheral of claim 1, wherein the sensor assembly is configured to recover data corresponding to a microscopic code embedded on a surface of an object.

6. The peripheral of claim 1, wherein the housing comprises a conformal cavity to receive the communications device.

7. The peripheral of claim 6, further comprising a protective window over the conformal cavity to protect a display screen of the preexisting handheld communication device when disposed within the conformal cavity of the housing.

8. The peripheral of claim 7, wherein the protective window is made of polycarbonate plastic or acrylonitrile butadiene styrene (ABS) plastic.

9. A method for utilizing a peripheral device in association with a preexisting handheld communication device, the method comprising:
receiving the preexisting handheld communication device via a housing of the peripheral device;
removably coupling the preexisting handheld communication device to a connector assembly disposed in the housing of the peripheral device; and
generating user data via a sensor assembly disposed in association with the housing, the sensor assembly including:
an optical image sensor for acquiring image information; and
a processor for receiving and processing the image information to generate the user data.

10. The method of claim 9, further comprising conveying power from the preexisting handheld communication device to the sensor assembly via the connector assembly.

11. The method of claim 10, wherein the power is conveyed via a USB connector.

12. The method of claim 9, wherein the sensor assembly is removable from the housing by an end user.

13. The method of claim 9, wherein the user data corresponds to a microscopic code embedded on a surface of an object.

14. The method of claim 9, further comprising receiving the preexisting communications device via a conformal cavity in the housing.

15. The method of claim 14, wherein a screen of the preexisting handheld communication device is protected by a protective window positioned over the conformal cavity.

16. The method of claim 15, wherein the protective window is made of polycarbonate plastic or acrylonitrile butadiene styrene (ABS) plastic.

17. A peripheral to a preexisting handheld communication device, consisting essentially of:
a housing;
a power source;
a wireless communication assembly disposed in the housing; and
a sensor assembly disposed the housing, the sensor assembly operably associated with the wireless communication assembly,
wherein the power source operably powers the wireless communication assembly and sensor assembly and the wireless communication assembly is capable of establishing an operable wireless link with the preexisting handheld communication device.

18. The peripheral of claim 17, wherein the sensor assembly includes an optical image sensor for acquiring image information.

19. The peripheral of claim 18, wherein the image information is processed by the preexisting handheld communication device.

20. The peripheral of claim 18, further consisting essentially of an image processor operably coupled between the sensor assembly and wireless communication assembly.

21. The peripheral of claim 17, wherein the sensor assembly is configured to recover data corresponding to an optical code embedded on a surface of an object.

22. The peripheral of claim 17, wherein the housing comprises a conformal cavity to receive the communications device.

23. The peripheral of claim 22, further consisting essentially of a protective window over the conformal cavity to protect a display screen of the preexisting handheld communication device when disposed within the conformal cavity of the housing.

24. The peripheral of claim 23, wherein the protective window is made of polycarbonate plastic or acrylonitrile butadiene styrene (ABS) plastic.

25. A method for utilizing a peripheral device in association with a preexisting handheld communication device, the method comprising:
establishing a wireless communication link between a preexisting handheld communication device and a peripheral device having wireless communication assembly, the peripheral device consisting essentially of:
a housing with power source; and
a sensor assembly disposed the housing, the sensor assembly operably associated with the wireless communication assembly; and
generating user data via the sensor assembly.

26. The method of claim 25, further comprising acquiring image information from an optical code disposed on a surface via the sensor assembly.

27. The method of claim 26, further comprising processing the acquired image information in the preexisting handheld communication device.

28. The method of claim 26, further comprising processing the acquired image information in the peripheral device.
